(19) United States
(12) Patent Application Publication
(10) Pub. No.: US 2016/0082670 A1
(43) Pub. Date: Mar. 24, 2016

(54) STAGE FOR USE IN A 3D PRINTER

(71) Applicant: MOBIUM SOLUTIONS, LLC, State College, PA (US)

(72) Inventors: Kevin Randolph PARODA, State College, PA (US); Justin Joseph KEENAN, State College, PA (US)

(73) Assignee: MOBIUM SOLUTIONS, LLC, State College, PA (US)

(21) Appl. No.: 14/861,854

(22) Filed: Sep. 22, 2015

Related U.S. Application Data
(60) Provisional application No. 62/053,651, filed on Sep. 22, 2014.

(51) Int. Cl. B29C 67/00; B29C 37/00

(52) U.S. Cl. CPC B29C 67/0092; B29C 67/0055; B29C 37/0003; B29K 2905/02; B33Y 30/00

(57) ABSTRACT

The present disclosure generally relates to a stage for use in a 3D printer. The stage is designed to permit a vacuum device to be coupled thereto to ensure a substantially flat build station. The device also includes a movable surface upon which an object will be printed. Once the object is printed, the movable surface moves the printed object away from the build area of the stage so that the next object may be printed.

### CROSS-REFERENCE TO RELATED APPLICATIONS

This application claims benefit of United States Provisional Patent Application Ser. No. 62/053,651, filed Sep. 22, 2014, which is herein incorporated by reference.

### BACKGROUND OF THE DISCLOSURE

1. Field of the Disclosure

Embodiments of the present disclosure generally relate to a stage for use in a 3D printer.

2. Description of the Related Art

Once merely science fiction, 3D printers are now a reality. Industry experts are predicting that the near future, every classroom will have a 3D printer. 3D printers are even used in the medical industry. Exact replicas of a patient's internal organs are printed so that the surgeon can view the organ prior to surgery. With such advancements, there will be fewer errors once the surgery begins. For home applications, 3D printers can be used to create replacement parts. For example, if a cup is broken, a 3D printer can be used to simply print a new cup. 3D printers can be used to make crafts such as holiday ornaments.

In current 3D printers, the desired object is printed on a stage. Once completed, the object needs to be removed before the next object can be printed. If there are multiple users each printing at least one object, or perhaps one user printing multiple objects, delays can be incurred since someone needs to be physically present to remove each object after one object has been printed so that the next object can be printed.

Therefore, there is a need in the art for a manner to ensure that multiple objects can be printed in a 3D printer without needing a user to physically remove the printed object from the 3D printer, thereby increasing the 3D printer efficiency and utilization capacity.

### SUMMARY OF THE DISCLOSURE

The present disclosure generally relates to a stage for use in a 3D printer. The stage is designed to permit a vacuum device to be coupled thereto to ensure a substantially flat build station. The device also includes a movable surface upon which an object will be printed. Once an object is printed, the movable surface moves the printed object away from the build area of the stage so that the next object may be printed.

In one embodiment, a stage for use in a 3D printer. The 3D printer includes a base plate; a stage plate coupled to the base plate, the stage plate having a plurality of openings therethrough; a first arm coupled to the base plate and extending away from the base plate; a second arm coupled to the base plate and extending away from the base plate, wherein the second arm extends parallel to the first arm; a roller bar coupled to both the first arm and the second arm and extending therebetween; a movement mechanism coupled to the first arm and the second arm; and a control mechanism coupled to the movement mechanism, wherein the control mechanism is capable of causing the movement mechanisms to move relative to the stage plate.

In another embodiment, a 3D printer comprises an extruder; and a stage. The stage comprises: a base plate; a stage plate coupled to the base plate, the stage plate having a plurality of openings therethrough; a first arm coupled to the base plate and extending away from the base plate; a second arm coupled to the base plate and extending away from the base plate, wherein the second arm extends parallel to the first arm; a roller bar coupled to both the first arm and the second arm and extending therebetween; a movement mechanism coupled to the first arm and the second arm; and a control mechanism coupled to the movement mechanism, wherein the control mechanism is capable of causing the movement mechanisms to move relative to the stage plate.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is an isometric illustration of a 3D printer including a stage according to one embodiment.

FIG. 2 is an exploded isometric illustration of a stage according to one embodiment.

FIG. 3 is a top illustration of stage according to one embodiment.

FIG. 4 is a top illustration of a stage with a portion of the stage plate removed.

FIG. 5 is a side view of a 3D printer containing the stage having an object formed thereon according to one embodiment.

FIG. 6 is a side view of a 3D printer containing the stage having an object formed thereon that has been partially moved out of the build area.

FIG. 7 is a side view of a 3D printer containing the stage having an object formed thereon that has been partially moved out of the build area.

FIG. 8 is a side view of a 3D printer containing the stage having an object formed thereon that has been moved out of the build area.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to a stage for use in a 3D printer. The stage is designed to permit a vacuum device to be coupled thereto to ensure a substantially flat build station. The device also includes a movable surface upon which an object will be printed. Once the object is printed, the movable surface moves the printed object away from the build area of the stage so that the next object may be printed.

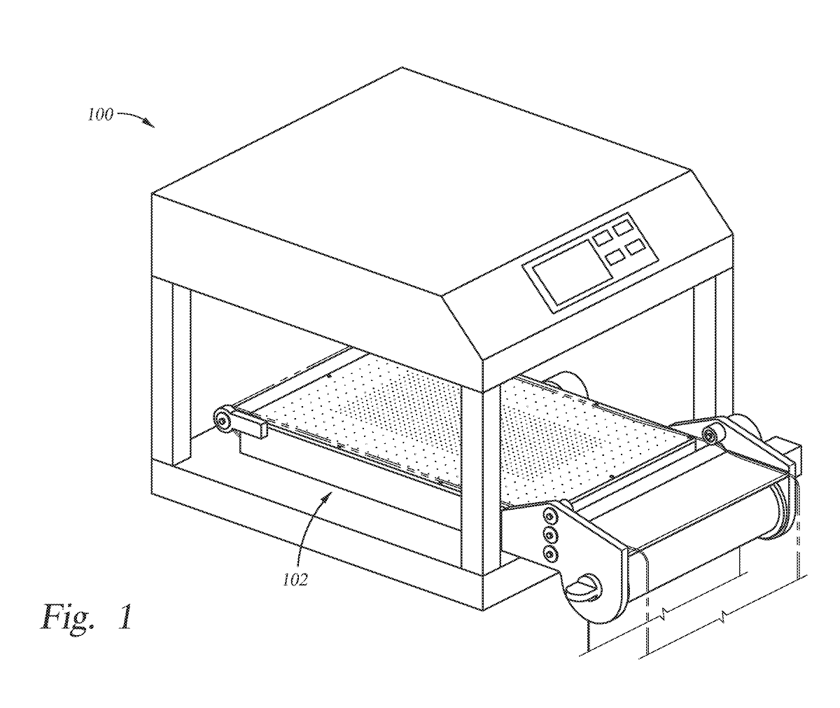

FIG. 1 is an isometric illustration of a 3D printer 100 including a stage 102 according to one embodiment. The 3D printer 100 is not restricted to printing plastic based material. It is to be understood that the 3D printer is capable of printing any number of materials and is not restricted to the ability to print any particular material. Additionally, while the stage 102 is shown to extend beyond the body of the 3D printer 100, the stage 102 size is not so limited. Rather, the stage 102 may be sized to be completely contained within the body of the 3D printer 100 or be sized to accommodate a custom 3D printer application.

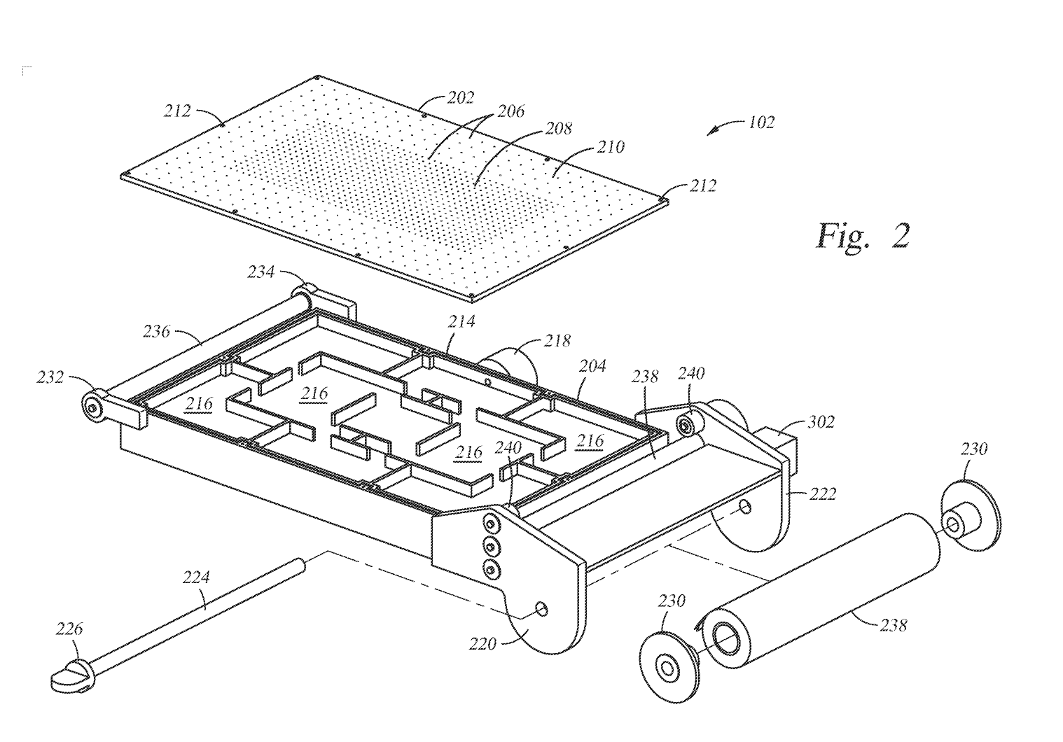

FIG. 2 is an exploded isometric illustration of the stage 102 according to one embodiment. The stage 102 includes a stage plate 202 and a base plate 204. As shown in FIG. 2, the stage plate 202 has a plurality of openings 206 extending therethrough. In one embodiment, the openings 206 have a diameter of between about 1/32 inches and about ⅛ inches, such as about 1/16 inches. There is a higher concentration of openings in the center area 208 of the stage plate 202 as compared to the edge area 210. A plurality of fastening openings 212 are also present for fastening the stage plate 202 to the base plate 204. In one embodiment, the stage plate 202 comprises aluminum. It is to be understood that other metallic materials may be utilized as well for the stage plate 202. In one embodiment, the base plate 304 comprises commercially available plastic, such as PVC.

An elastomeric sealing member 214, such as an O-ring, is used between the stage plate 202 and the base plate 204 so that the stage plate 202 is sealed to the base plate 204. The base plate 204 includes a plurality of regions 216 that are all connected. The plurality of regions 216 are all arranged to ensure a symmetric vacuum is drawn through the openings 206. A vacuum connection 218 is also present. It is to be understood that the location of the vacuum connection 218 is not limited to the side of the base plate 204, but rather, may be disposed at any desirable location. The vacuum connection is used to prevent/minimize deformation of the object being printed, such as warping or curling.

A first arm 220 extends from the stage plate 202 in a first direction. Additionally, a second arm 222 extends from the stage plate 202 in the first direction such that the first arm 220 and the second arm 222 are substantially parallel. A first roller bar 224 extends between the first arm 220 and the second arm 222. A handle 226 is shown coupled to the first roller bar 224. During operation, a movable build surface is used. The movable build surface is initially on a roll 228 that is disposed on the first roller bar 224. End caps 230 are used to hold the roll 228 to the first roller bar 224.

A third arm 232 and a fourth arm 234 are also coupled to the stage plate 204. The first arm 232 extends from the stage plate 204 in a direction opposite to the first direction. Additionally, the third arm 232 is substantially parallel to the first arm 220. Similarly, the fourth arm extends from the stage plate 204 in a direction opposite to the first direction. Additionally, the fourth arm 234 is substantially parallel to the second arm 222 and the third arm 232. A second roller bar 236 extends between the third arm 232 and the fourth arm 234. The first arm 220, second arm 222, third arm 232 and fourth arm 234 may comprise plastic, but it is to be understood that other materials may be utilized as well.

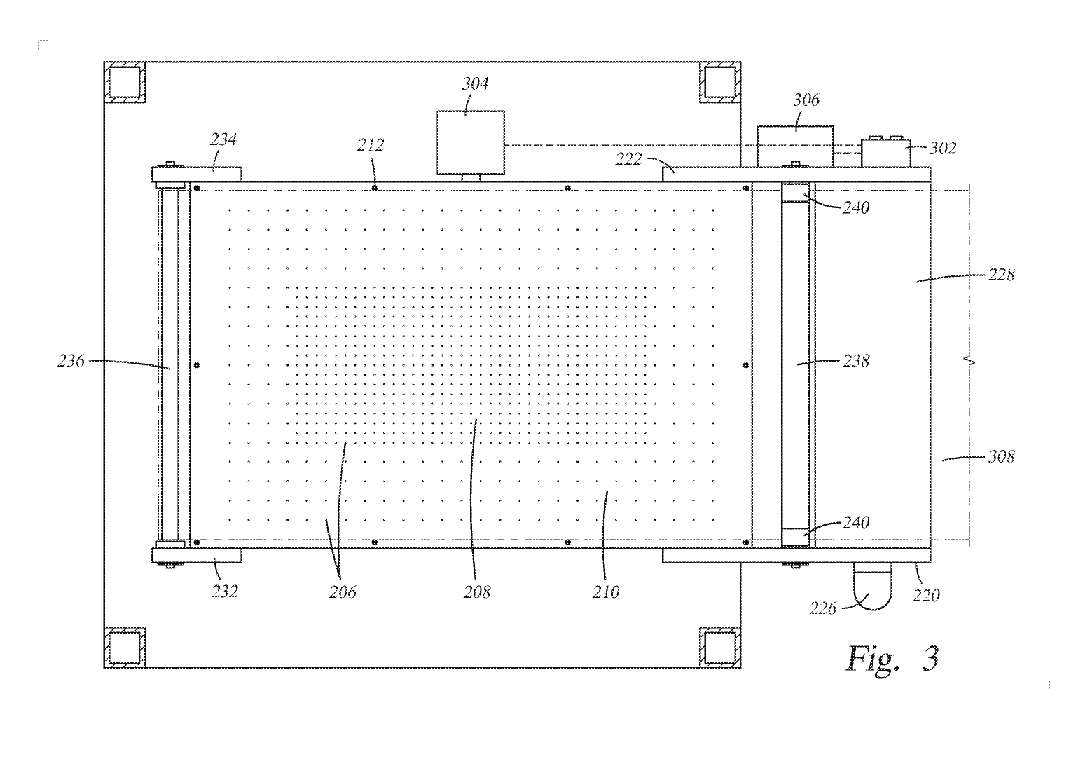

A third roller bar 238 extends between the first arm 220 and the second arm 222. The third roller bar 238 is spaced from the first roller bar 224. Movement mechanisms 240 are also coupled to the first arm 220 and the second arm 222. In the embodiment shown in FIG. 2, the movement mechanism 240 is a wheel, and a movement mechanism 240 is separately coupled to each arm. The movement mechanism 240 is coupled to a controller 302 (shown in FIG. 3) that causes the movement mechanism 240 to move as will be described below. In one embodiment, the movement mechanism 240 may comprise spring loaded rollers.

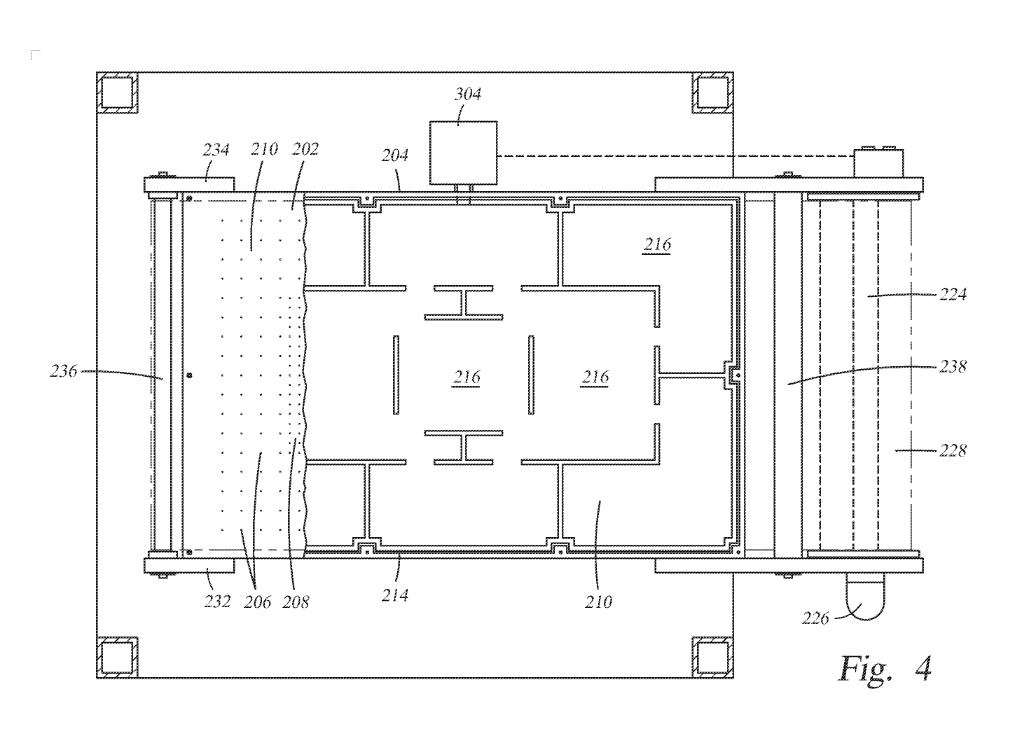

FIG. 3 is a top illustration of stage 102 according to one embodiment. As shown in FIG. 3, the controller 302 is coupled to a vacuum device 304 that is coupled to the vacuum connection 218. The controller 302 is also coupled to a movement mechanism motor 306. A movable build surface 308 is shown in phantom and moves from the roll 228. In one embodiment, the build surface 308 is a plastic material such as PVC or ABS and has a thickness of between about 4 mils and about 10 mils, such as about 8 mils. The build surface 308 is vacuumed to the stage plate 202 during operation and must therefore be flexible and uniform in how the build surface 308 lays on the surface. In one embodiment, the build surface 308 has a melting point of at least about 160 degrees Celsius. In operation, when an object is to be printed onto the build surface 308, the controller 302 activates the vacuum device 304. The vacuum device 304 may be activated prior to the beginning of the 3D printing. The vacuum device 304 draws a vacuum between the stage plate 102 and the movable build surface 308 such that the movable build surface 308 is pulled into close proximity to the stage plate 102 and a substantially level surface is present for the printing. FIG. 4 is a top illustration of stage 102 with a portion of the stage plate 202 removed. In one embodiment, the surface of the stage plate 202 upon which the build surface 308 is disposed during operation is roughened to have a surface roughness that is different than the surface roughness of the side of the stage plate 202 opposite thereto. In one embodiment, the surface roughness is greater on the surface upon which the build surface 308 will be disposed.

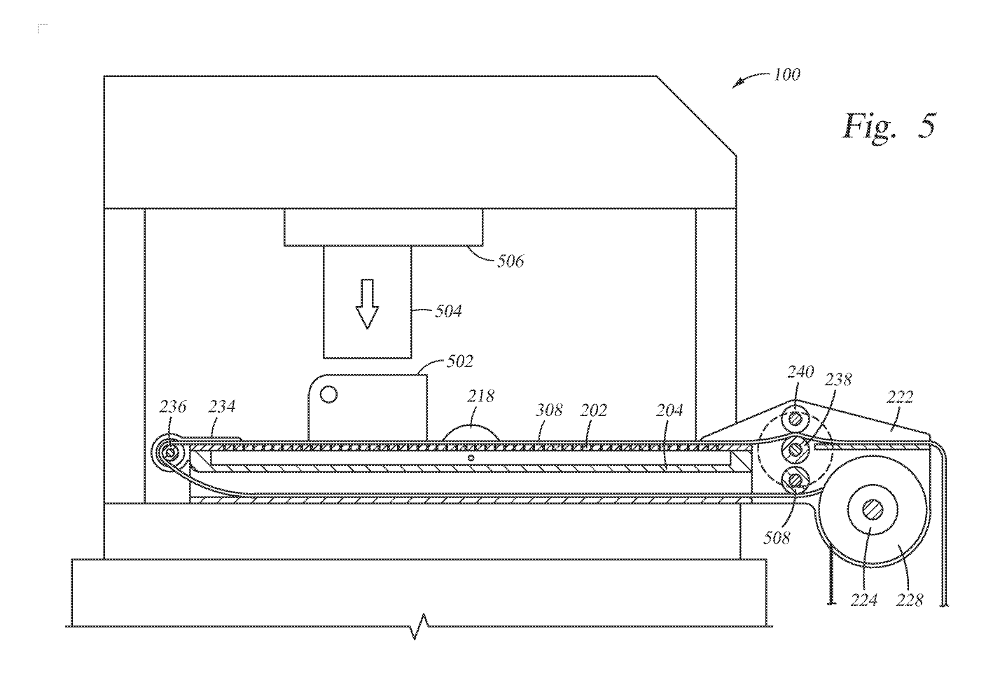

FIG. 5 is a side view of a 3D printer 100 containing the stage 102 having an object 502 formed thereon according to one embodiment. The object 502 is formed by introducing the deposition material 504 from a deposition source 506. As discussed above, the deposition material 504 is not limited. A fourth roller bar 508 may be present and extending between the first arm 220 and the second arm 222 to ensure the build surface 308 is movable through the system. As shown in FIG. 5, the third roller bar 238 is in a first position such that the build surface 308 is in contact with the stage plate 202.

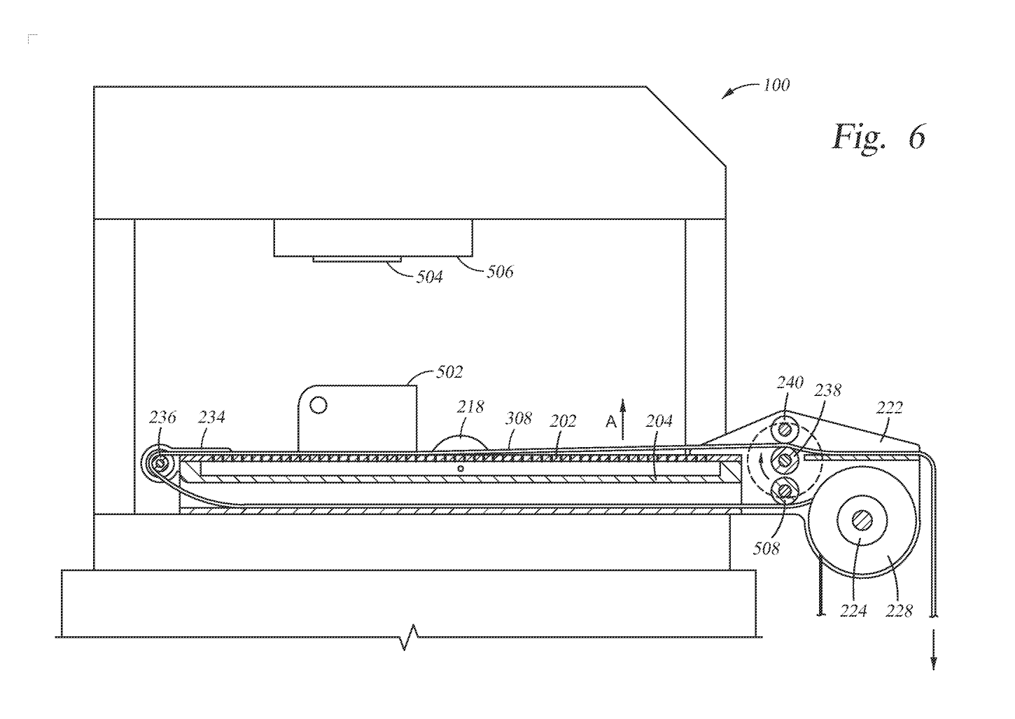

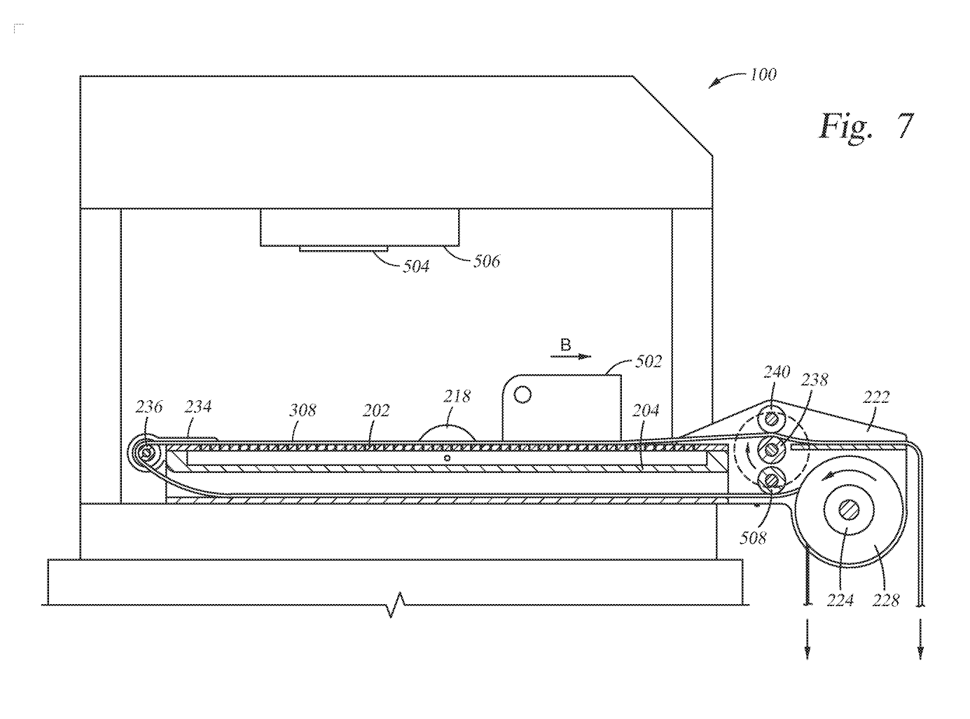

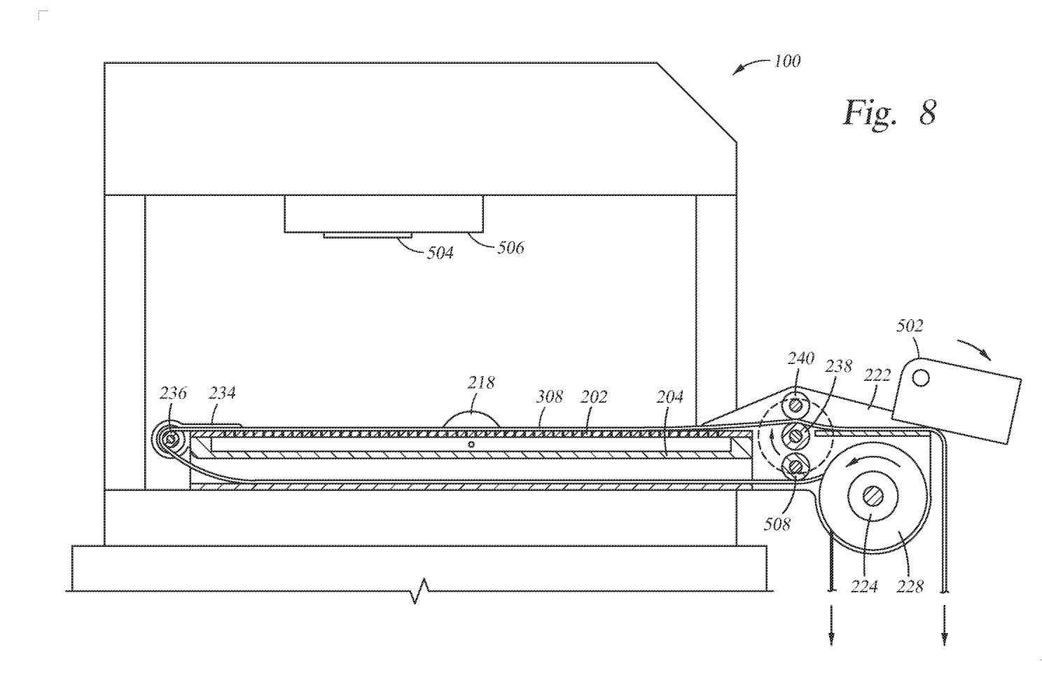

FIG. 6 is a side view of the 3D printer 100 containing the stage 102 having an object 502 formed thereon that has been partially moved out of the build area. FIG. 7 is a side view of the 3D printer 100 containing the stage 102 having the object 502 formed thereon that has been partially moved out of the build area. FIG. 8 is a side view of the 3D printer 100 containing the stage 102 having the object 502 formed thereon that has been moved out of the build area. FIGS. 6-8 will be discussed in terms of the operation of the stage 102 and printer 100.

In FIG. 6, the object 502 is completely formed and thus the deposition has completed. Now is the time to remove the object 502 from the stage 102. In the past, a user had to physically grab the object 502 and remove the object 502 from the stage 102 before the next object could be formed. With stage 102, the user is not needed to remove the object 502.

To remove the object 502 from the build area, the vacuum is disengaged such that the build surface 308 is no longer vacuumed to the stage plate 202. In one embodiment, air may be delivered through the stage 102 to assist as a “puff” of air to help disengage the build surface 308 from the stage plate 202. The third roller bar 238 and movement mechanism 204 moves vertically as shown by arrow “A” where the vertical movement is perpendicular to the stage plate 202 surface upon which the build surface 308 is disposed during deposition. By moving the movement mechanism 240 and third roller bar 238, the build surface 308 is at least partially lifted from the stage plate 202 and thus easier to move. The movement mechanism 240 then moves which causes the build surface 308, and object 502 thereon, to move. As shown in FIG. 7, the object 502 has moved away from the deposition location in the direction of arrow “B”. As shown in FIG. 8, the object 502 has cleared the stage 102. As the build surface 308 moves, roller bars 224, 236, 238 and 508 all move due to contact with the build surface 308 or roll 228.

In operation, a 3D printer using the stage 102 described herein will operate as follows. Initially, one or more users will send a computer file, such as a CAD file, of the object to be printed to the 3D printer. The 3D printer will “cue” the objects to be printed in a first come-first printed order. In one embodiment, the 3D printer will “cue” the objects to be printed on a priority based system where higher priority objects may “jump the line” and be processed before lower priority objects even though the lower priority objects print jobs were “sent” to the 3D printer prior to the high priority object print jobs. If the build surface is already clear, then the 3D printer will then vacuum the build surface to the top surface of the stage plate. The desired object will then be printed. Once the object is complete, then the vacuum will be removed and, optionally, air may be puffed through the openings to release the build surface. The roller bar will move perpendicular to the stage plate to disengage the build surface from the stage plate. The rollers will then operate to move the build surface, and the object attached thereto, out of the printer. A sensor, such as an IR beam sensor, will detect when the object has cleared the 3D printer and the build surface is clear for printing. At that point, the process repeats with the next object being printed. In so doing, not only is the object printed on a flat surface, but the printed object is then moved out of the way so that the next cued object can be printed.

The stage shown and described herein is beneficial not only due to the ability to move the object out of the way automatically without the need for a user to physically move the device, but also for the surface upon which the object is built. On conventional stages, the object will oftentimes stick to the stage and hence, be damaged during removal. With the build surface utilized here, the build surface can be disengaged from the object without any damage due to the design of the build surface and flexibility of the surface material.

While the foregoing is directed to embodiments of the present disclosure, other and further embodiments of the disclosure may be devised without departing from the basic scope thereof, and the scope thereof is determined by the claims that follow.

What is claimed is:

1. A stage for use in a 3D printer, comprising:
a base plate;
a stage plate coupled to the base plate, the stage plate having a plurality of openings therethrough;
a first arm coupled to the base plate and extending away from the base plate;
a second arm coupled to the base plate and extending away from the base plate, wherein the second arm extends parallel to the first arm;
a roller bar coupled to both the first arm and the second arm and extending therebetween;
a movement mechanism coupled to the first arm and the second arm; and
a control mechanism coupled to the movement mechanism, wherein the control mechanism is capable of causing the movement mechanisms to move relative to the stage plate.

2. The stage of claim 1, wherein the base plate and the stage plate are coupled together such that a space is present between the base plate and the stage plate in an area corresponding to the plurality of openings.

3. The stage of claim 1, wherein the plurality of openings are non-uniformly distributed across the stage plate.

4. The stage of claim 3, wherein a greater number of openings are present in the center of the stage plate as compared to the edge of the stage plate.

5. The stage of claim 1, wherein the stage plate comprises aluminum.

6. The stage of claim 1, further comprising:
a third arm coupled to the base plate and extending away from the base plate in a direction opposite to the first arm; and
a fourth arm coupled to the base plate and extending away from the base plate in a direction opposite to the second arm.

7. The stage of claim 6, wherein the third arm is parallel to the fourth arm.

8. The stage of claim 1, further comprising a second bar extending between the first arm and the second arm, wherein the second bar is moveable relative to the stage plate in a direction substantially perpendicular to a processing plane of the stage plate.

9. The stage of claim 1, wherein the movement mechanism comprises a first wheel coupled to the first arm and a second wheel coupled to the second arm.

10. The stage of claim 1, wherein the base plate comprises a non-metal.

11. A 3D printer, comprising:
an extruder; and
a stage, wherein the stage comprises:
a base plate;
a stage plate coupled to the base plate, the stage plate having a plurality of openings therethrough;
a first arm coupled to the base plate and extending away from the base plate;
a second arm coupled to the base plate and extending away from the base plate, wherein the second arm extends parallel to the first arm;
a roller bar coupled to both the first arm and the second arm and extending therebetween;
a movement mechanism coupled to the first arm and the second arm; and
a control mechanism coupled to the movement mechanism, wherein the control mechanism is capable of causing the movement mechanisms to move relative to the stage plate.

12. The 3D printer of claim 11, wherein the base plate and the stage plate are coupled together such that a space is present between the base plate and the stage plate in an area corresponding to the plurality of openings.

13. The 3D printer of claim 11, wherein the plurality of openings are non-uniformly distributed across the stage plate.

14. The 3D printer of claim 13, wherein a greater number of openings are present in the center of the stage plate as compared to the edge of the stage plate.

15. The 3D printer of claim 11, wherein the stage plate comprises aluminum.

16. The 3D printer of claim 11, further comprising:
a third arm coupled to the base plate and extending away from the base plate in a direction opposite to the first arm; and
a fourth arm coupled to the base plate and extending away from the base plate in a direction opposite to the second arm.

17. The 3D printer of claim 16, wherein the third arm is parallel to the fourth arm.

18. The 3D printer of claim 11, further comprising a second bar extending between the first arm and the second arm, wherein the second bar is moveable relative to the stage plate in a direction substantially perpendicular to a processing plane of the stage plate.

19. The 3D printer of claim 11, wherein the movement mechanism comprises a first wheel coupled to the first arm and a second wheel coupled to the second arm.

20. The 3D printer of claim 11, wherein the base plate comprises a non-metal.
